(19) United States
(12) Patent Application Publication
(10) Pub. No.: US 2018/0200681 A1
(43) Pub. Date: Jul. 19, 2018

(54) Systems and Methods For Affecting Rates of Gas Evolution and Dissolution

(71) Applicants: Chevron U.S.A. Inc., San Ramon, CA (US); The Board of Regents for Oklahoma State University, Stillwater, OK (US)

(72) Inventors: Aniruddha V. Kelkar, Houston, TX (US); David Michael Lavenson, Houston, TX (US); Clint P. Aichele, Stillwater, OK (US); Alden Brack Daniel, Stillwater, OK (US)

(21) Appl. No.: 15/408,947

(22) Filed: Jan. 18, 2017

(51) Int. Cl. B01F 3/04; B01F 7/20; B01F 15/00

(52) U.S. Cl. CPC B01F 3/04602; B01F 7/20; B01F 15/00253; B01F 15/00915; B01F 15/00844

(57) ABSTRACT

A system for evolving and dissolving a gas with a liquid can include a vessel having at least one wall forming a cavity, where the at least one wall includes at least one first surface feature disposed on an inner surface of the at least one wall. The liquid and the gas can be disposed within the cavity. The at least one first surface feature can alter the rate at which the gas evolves from or dissolves into the liquid.

### CROSS-REFERENCE TO RELATED APPLICATIONS

The present disclosure is related to U.S. patent application Ser. No. 15/385,059, titled “Systems and Methods For Gas Evolution and Dissolution” and filed on Dec. 20, 2016, the entire contents of which are hereby incorporated herein by reference.

### TECHNICAL FIELD

The present disclosure relates generally to gas evolution and dissolution, and more specifically to affecting the rates of the evolution from and dissolution of gas in liquid.

### BACKGROUND

Gas evolution is a physical or chemical process where gas is produced as free gas or bubbles or foam from a supersaturated solution (storing more gas than the “saturation level” governed by thermodynamics (e.g., system pressure, temperature, and composition)). Gas dissolution is a different physical or chemical process by which a gas (in the form of free gas, bubbles or foam) is transferred to an undersaturated solution (storing less gas than the thermodynamic “saturation level”). Factors such as system temperature and pressure, level of agitation, and fluid properties affect gas evolution and gas dissolution. Gas evolution and dissolution is encountered in and can be used in a number of applications. For example, gas evolution occurs in carbonated beverages, where carbon dioxide is evolved at the time the beverage is served.

### SUMMARY

In general, in one aspect, the disclosure relates to a system for changing a state of a gas relative to a liquid. The system can include a vessel comprising at least one wall forming a cavity, where the at least one wall has at least one first surface feature disposed on an inner surface of the at least one wall. The liquid and the gas can be disposed within the cavity. The at least one first surface feature can alter the rate at which the gas evolves from or dissolves into the liquid.

In another aspect, the disclosure can generally relate to a system for changing a state of a gas relative to a liquid. The system can include a vessel comprising at least one wall forming a cavity. The system can also include a component disposed within the cavity, where the component comprises at least one outer surface on which at least one first surface feature is disposed. The liquid and the gas can be disposed within the cavity. The at least one first surface feature can alter the rate at which the gas evolves from or dissolves into the liquid.

In yet another aspect, the disclosure can generally relate to a pipe used to feed a gas to a vessel used for changing a state of the gas relative to a liquid, where the pipe has at least one wall forming a cavity, where the at least one wall has at least one first surface feature disposed on an inner surface of the at least one wall, where the gas is disposed within the cavity, and where the at least one first surface feature alters the manner in which the gas travels through the cavity to the vessel.

These and other aspects, objects, features, and embodiments will be apparent from the following description and the appended claims.

### BRIEF DESCRIPTION OF THE DRAWINGS

The drawings illustrate only example embodiments of methods, systems, and devices for affecting rates of gas evolution and dissolution. Example embodiments can be applied to any of a number of applications. For instance, example embodiments can be used during a production field operation of a subterranean formation. Therefore, example embodiments described herein are not to be considered limiting of its scope, as affecting rates of gas evolution and/or dissolution may admit to other equally effective embodiments and/or applications. This is similarly applied to drawings illustrating any systems described herein. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIGS. 1A and 1B show a diagram of a system for evolving and dissolving gas in accordance with certain example embodiments.

FIGS. 2A-2D show a cycle for evolving gas in accordance with certain example embodiments.

FIGS. 3A-6B shows various surface treatments in accordance with certain example embodiments.

### DETAILED DESCRIPTION OF EXAMPLE EMBODIMENTS

The example embodiments discussed herein are directed to systems, apparatuses, and methods of affecting rates for evolving and dissolving gases. Example systems for affecting rates for evolving and dissolving gases described herein can be used in any type of container (e.g., pressurized) in which a gas can be evolved and/or dissolved. Example embodiments can be used in any of a number of applications, including but not limited to production field operations, industrial operations, production of plastics, volcanic activity, sulfur removal pits, diving, solutions produced through electrolysis, chemical plants, biomedical practice, separators, pumps, tanks, and production facilities.

For example, gas-liquid separation is a critical unit operation in crude oil production. In typical upstream oil and gas operations, the multiphase fluids produced from oil wells are separated and processed before being exported as sales and waste streams. These multiphase fluids present numerous challenges in processing, where any issues in design and operation of separators creates bottlenecks requiring equipment adjustments. These alterations add operating costs, increase downtime, and/or reduced throughput, all of which result in lost value.

As another example, the unexpected evolution of additional gas in a pipeline or flowline can lead to concerns such as unplanned slugging, increased backpressure, and over prediction of pressure drop, particularly with more viscous liquids. This can compromise the integrity of the flowlines, risers, topsides, and other equipment. For proper design of compact systems, engineers must be able to determine the residence time required to meet the desired outlet gas volume fraction (GVF) specifications with reasonable certainty. Controlling the rate of evolution and dissolution of gas using example embodiments can solve these problems.

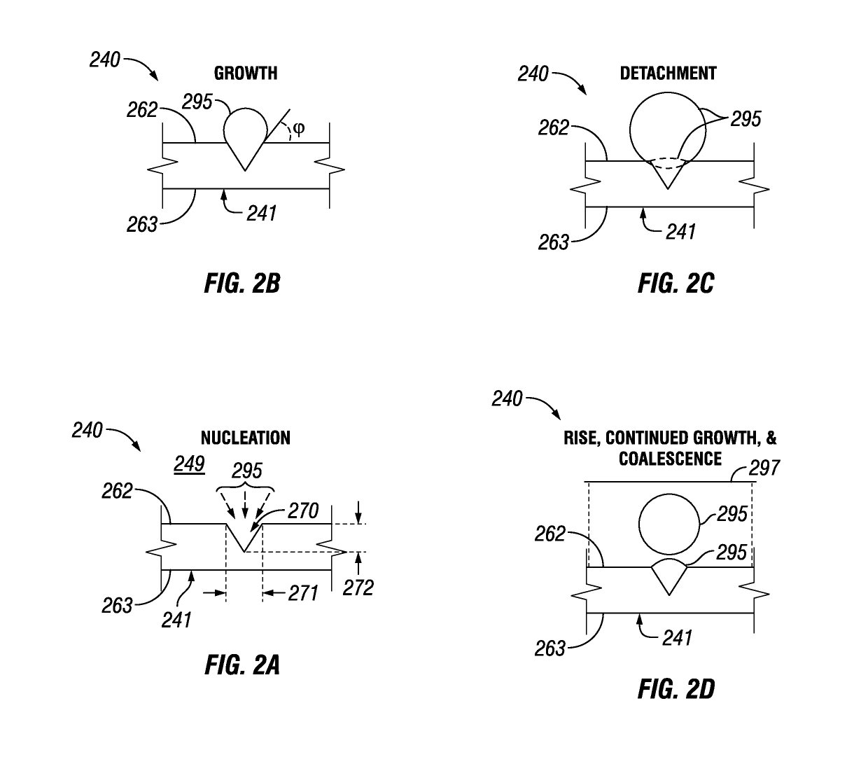

For illustrative purposes, consider a multiphase (e.g., oil, gas, and water) stream reaching a production choke (a type of valve) upstream of a compact subsea separator. After taking a substantial pressure drop at the choke, the solution gas must disengage from the liquid to reach the new thermodynamic equilibrium. This can include the time for solution gas to form bubbles, grow, rise and reach the bulk gas-liquid interface (as described below in FIGS. 2A-2D). This process must conclude within the liquid residence time (which for compact systems can be as low as 30 seconds) in the inlet piping and the vessel.

While the time to approach equilibrium after a pressure drop is quick, it is not instantaneous. Quantifying the amount of time required for gas evolution is, however, difficult at best, given the lack of comprehensive predictive models. With short residence times, the margin for error in estimating the extent of gas-liquid separation in the vessel is small, but the cost of miscalculations is high. Example embodiments can alter the rate of gas evolution and/or dissolution, greatly reducing this risk and associated cost.

The transience of gas evolving out of solution (e.g., liquid) can be a concern for heavy oil production, as well. Heavy oil is notorious for having processing challenges related to gas-liquid and liquid-liquid separation with heavy oil emulsions, foams, and gassy crudes, making separation difficult. Typical methods for gas-liquid and liquid-liquid separation of heavy crude oils involve a combination of gravity separation for long periods of time, chemicals, and heat. Example embodiments can be used to better study liquid-liquid separations of heavy oil emulsions as well as gas-liquid separations of these mixtures.

Another scope of example embodiments is to include modification of surface hydrophobicity. It has been theorized that, in an aqueous system, at the micron and sub-micron scale, there would exist hydrophobic impurities in the example surface features, thus creating a lack of liquid at the bottom of the surface features. Where there is no liquid, there exists a gas microbubble which can serve as an initial ‘seeding’ bubble for the nucleation and evolution processes. Therefore, example embodiments can be applicable to the oil and gas industry using either hydrophobic or oleophobic surfaces, depending on the bulk liquid phase being separated. Example surface features that can alternate between oleophobic and hydrophobic would be deployed for applications (e.g., fields) with varying production rates over the field life (e.g., low water cuts initially but increasing in late life). The example surface features can act to nucleate bubbles to enhance nucleation rates, which thereby enhances the rate of gas evolution. In other words, example embodiments can enable better and more reliable gas-liquid separation.

A liquid as used herein can be any one or more substances that are free flowing and having constant volume. Examples of a liquid can include, but are not limited to, water, drilling mud, blood, liquid sulfur, polymers, and oil. A gas as used herein can be one or more of any air-like fluid substances that expand freely to fill any space available (e.g., head space). A gas as used herein can be a free gas, bubbles, gas that is in solution, and/or foam. Examples of a gas can include, but are not limited to, natural gas, nitrogen, methane, air, hydrogen sulfide, carbon monoxide, and carbon dioxide.

Example embodiments can be used in a laboratory setting. Alternatively, example embodiments can be used in a production or other real-time, practical application (e.g., in an operating vessel, at a drilling site, at a production facility, processing facility). In some cases, vessels in which example embodiments are used are put under high pressures. In such a case, adequate safety precautions can be taken to ensure that any accidents are contained and do not adversely affect people or other equipment.

A user as described herein may be any person that is involved with evolving and/or dissolving gases. Examples of a user may include, but are not limited to, a company representative, a drilling engineer, a field engineer, a chemist, a lab technician, an operator, a consultant, a contractor, and a manufacturer's representative. The systems for evolving and dissolving gases (including any components thereof) described herein can be made of one or more of a number of suitable materials to allow the systems for evolving and dissolving gases to maintain reliable and effective operations, meet certain standards and/or regulations, and also maintain durability in light of the one or more conditions (e.g., marine, high pressure, high temperature, subterranean) under which the systems for evolving and dissolving gases can be exposed and/or operate under. Examples of such materials can include, but are not limited to, aluminum, stainless steel, fiberglass, glass, plastic, ceramic, and rubber.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three digit number and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

In the foregoing figures showing example embodiments of affecting rates for gas evolution and dissolution, one or more of the components shown may be omitted, repeated, and/or substituted. Accordingly, example embodiments of affecting rates for gas evolution and dissolution should not be considered limited to the specific arrangements of components shown in any of the figures. For example, features shown in one or more figures or described with respect to one embodiment can be applied to another embodiment associated with a different figure or description.

As explained above, gas evolution is the process by which one or more gases that are dissolved in one or more liquids disengages from the liquid(s) due to pressure drop. Gas evolution is a composite of one or more of a number of processes, including but not limited to bubble nucleation, growth, rise, and coalescence. Both dissolution and evolution processes are critical to several oil and gas industry applications, including but not limited to liquid sulphur degassing, artificial lift using gas, boosting/pumping, and separations. There is very limited data available on controlling the rates of gas evolution and dissolution, and the resulting effects of controlling these rates. Example embodiments use modified surfaces to either enhance or inhibit the rate of gas evolution and/or dissolution.

Example embodiments of affecting rates for gas evolution and dissolution are described more fully hereinafter with reference to the accompanying drawings, in which example embodiments of affecting rates for gas evolution and dissolution are shown. Affecting rates for gas evolution and dissolution may, however, be embodied in many different forms and should not be construed as limited to the example embodiments set forth herein. Rather, these example embodiments are provided so that this disclosure will be thorough and complete, and will fully convey the scope of affecting rates for gas evolution and dissolution to those of ordinary skill in the art. Like, but not necessarily the same, elements (also sometimes called components) in the various figures are denoted by like reference numerals for consistency.

Terms such as “first,” “second,” “top,” “bottom,” “proximal”, “distal”, “inner,” “outer,” “within”, “front”, “rear”, and “side” are used merely to distinguish one component (or part of a component or state of a component) from another. Such terms are not meant to denote a preference or a particular orientation, and are not meant to limit embodiments of systems for gas evolution and dissolution. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

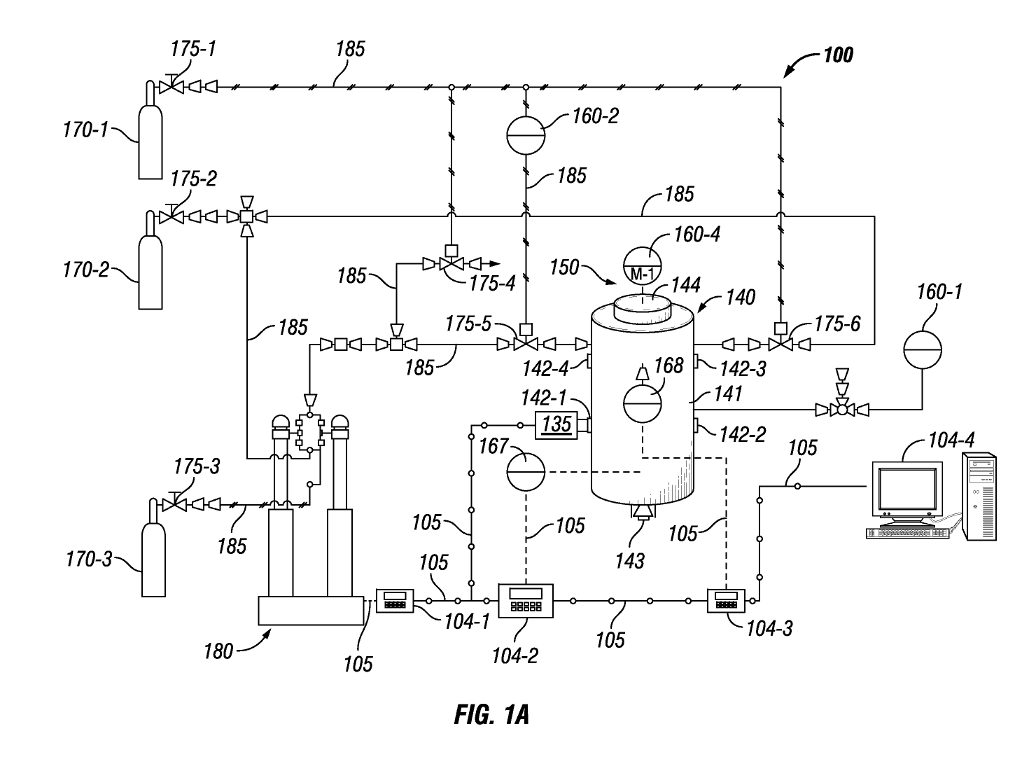

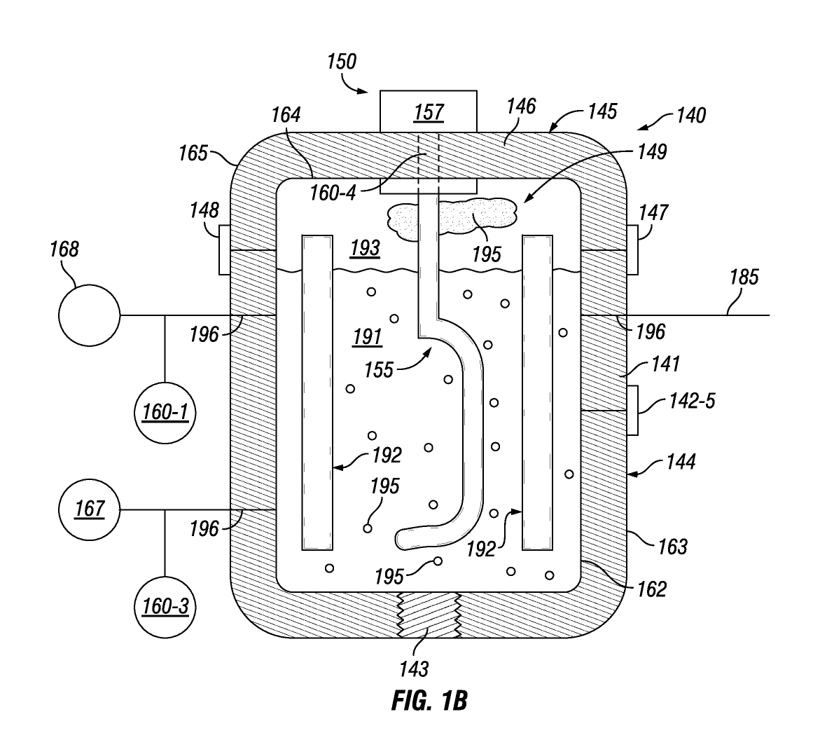

FIG. 1A shows a system 100 for evolving and dissolving gas in accordance with certain example embodiments. FIG. 1B shows a cross-sectional side view of the vessel 140 of FIG. 1A and some associated components. Referring to FIGS. 1A and 1B, the system 100 can include any of a number of components in accordance with certain example embodiments. In this case, as shown in FIGS. 1A and 1B, the system 100 includes a vessel 140, at least one sensor 160 (also called a sensor device 160 herein), one or more controllers 104, one or more pressure vessel (PV) content sources 170, at least one pump 180, a mixing device 150, one or more regulating devices (e.g., a pressure regulating device 168, a temperature regulating device 167), and an optional image capture device 135. These various components of the system 100 can be connected to at least one other component of the system 100 using piping 185 and/or signal transfer links 105. If piping 185 (e.g., pipes, elbows, flanges, expansion joints, tubes, fittings) is used, one or more control devices 175 (e.g., valves, regulators) can be used to regulate the medium (e.g., liquid, gas) that flows therethrough.

The vessel 140 can be a container of any shape and/or size. The vessel 140 can be designed to withstand a wide range of pressures (e.g., 1 atmosphere, 10,000 psia) and/or temperatures (e.g., 150° C., −100° C.). The vessel 140 can have at least one wall (e.g., wall 141, wall 146) that forms a cavity 149 that is designed to hold gases, liquids, and/or solids. The vessel 140 can be designed to hold any type of compound and/or material, including but not limited to acids, volatile compounds, corrosive material, bases, and water.

As defined herein, a vessel on which example surface features can be disposed can be a vessel 140, piping 185, a control device 175, a PV content source 170, a pump 180, and/or any other device or component that has a wall that forms a cavity. Also, more than one vessel in a system can have example surface features disposed thereon. In addition, or in the alternative, as discussed below, the outer surface of one or more components (e.g., a baffle 192, a paddle 155, suspended solids) disposed within a cavity formed by a vessel can have one or more example surface features disposed thereon.

The vessel 140 can also have any of a number of configurations. For example, as shown in FIG. 1B, the vessel 140 can have a body 144 and a cover 145 that couples to the body 144. In this case, the cover 145 is hingedly coupled to the body 144 by a hinge 147. Further, the cover 145 is secured to the body 144 by a latch mechanism 148. When viewed from above, the cover 145 and/or the body 144 can have any of a number of cross-sectional shapes. Such shapes can include, but are not limited to, a circle, an oval, a square, and an octagon.

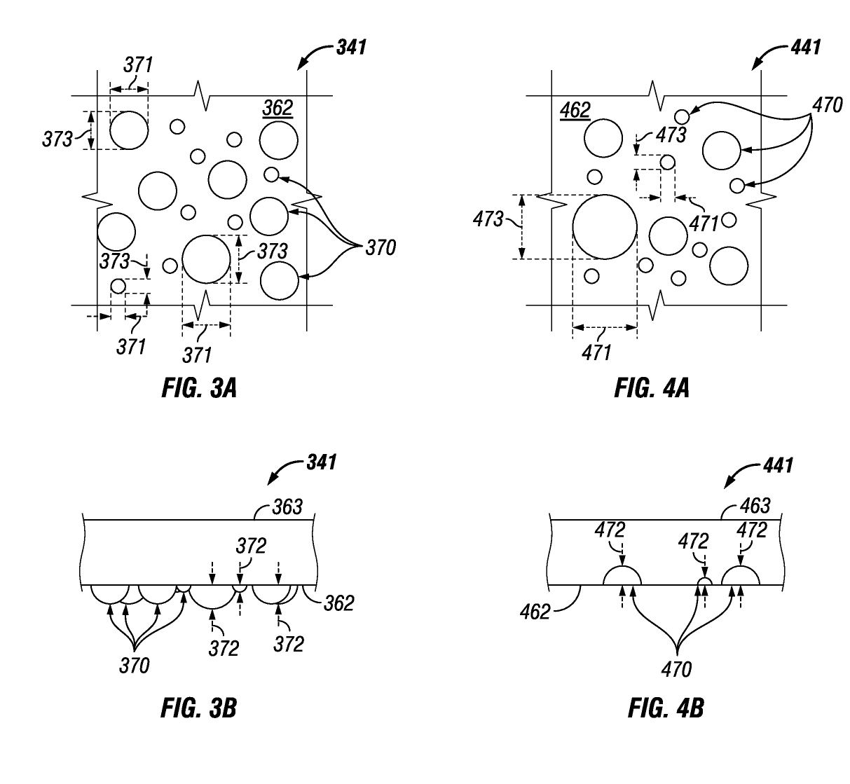

The body 144 can have at least one wall 141 that forms a cavity 149. The wall 141 of the body 144 has an inner surface 162 and an outer surface 163. The inner surface 162 of the body 144 can have any of a number of textures and/or features. Examples of such textures and/or features can include, but are not limited to, smooth, dimpled, rough, sharp-angled corners, rounded corners, and no corners. The textures and/or features of the inner surface 162 of the body 144 can be substantially uniform or variable throughout. Detailed examples of various textures and/or finishes of an inner surface 162 of a wall (e.g., wall 141) can be found in FIGS. 3A-6B below.

Similarly, the cover 145 has at least one wall 146. When the cover 145 is coupled to the body 144, the cavity 149 becomes enclosed. The wall 146 of the cover 145 has an inner surface 164 and an outer surface 165. When the cover 145 is coupled to the body 144, the inner surface 164 at the distal end of the cover 145 can form a seamless transition with the inner surface 162 at the distal end of the body 144. The textures and/or features of the inner surface 164 of the cover 145 can be substantially the same as, or different than, the textures and/or features of the inner surface 162 of the body 144.

Within the cavity 149 can be disposed a liquid 191 and a gas 195. The liquid 191 and the gas 195 can be in solution as a result of thermodynamic conditions with each other and/or out of solution relative to each other. Separating the gas 195 from the liquid 191 is evolution of the gas 195, and integrating the gas 195 with the liquid 191 is dissolution of the gas 195. When the gas 195 is integrated with the liquid 191, the gas 195 is suspended in the liquid 191. While FIG. 1B shows that there are bubbles of gas 195 in the liquid 191, this is not always the case. For example, the gas 195 can be “invisible” (in solution) within the liquid 191. As another example, the gas 195 can be a foam within or on top of the liquid 191. In other words, the gas 195 mixed in the liquid 191 can have any one or more of a number of forms.

Through the evolution process within the cavity 149, the gas 195 evolves (separates from the liquid 191) and accumulates in the headspace 193, which is the volume of space between the top of the liquid 191 and the inner surface 164 of the cover 145. When the gas 195 dissolves, at least most of the gas 195 (to the extent that the liquid 191 becomes saturated and can no longer absorb additional quantities of the gas 195) leaves the headspace 193 and becomes suspended in the liquid 191.

In some cases, the vessel 140 is pressurized to dissolve the gas 195 or depressurized to evolve the gas 195. The cavity 149 of the vessel 140 can be pressurized (or depressurized) by a pressure regulating device 168. The pressure regulating device 168 can increase, decrease, and/or maintain the pressure of the cavity 149. When the pressure regulating device 168 adjusts the pressure within the cavity 149, the adjustments can be made at any rate of change. Further, the range of pressures that can be generated by the pressure regulating device 168 can be at least as great as the range of pressures required to evolve and dissolve the gas 195 within the cavity 149.

The pressure regulating device 168 can include one or more of a number of components. Such components can include, but are not limited to, a pressure relief valve, a pressure regulating valve, fan, a pump, and a motor. The pressure regulating device 168 can be coupled to a controller 104 (in this case, controller 104-3), using signal transfer links 105, to receive power, control, and instructions from the controller 104, as well as to provide data and feedback to the controller 104.

In addition, or in the alternative, the temperature within the cavity 149 can be increased, decreased, and/or maintained using a temperature regulating device 167. When the temperature regulating device 167 adjusts the temperature of the cavity 149, the adjustments can be made at any rate of change. Further, the range of temperatures that can be generated by the temperature regulating device 167 can be at least as great as the range of temperatures required to evolve and dissolve the gas 195 within the cavity 149.

A temperature regulating device 167 can take on one or more of a number of forms, including but not limited to a resistive heating circuit and a cooling loop. A temperature regulating device 167 can include one or more of a number of components. Such components can include, but are not limited to, a fan, a pump, a motor, an insulator, a heat exchanger, and a heating element. The temperature regulating device 167 can have any of a number of configurations. For example, the temperature regulating device 167 can indirectly control the temperature of the wall 141 of the body 144 of the vessel 140, and the temperature of the wall 141 conducts to the contents within the cavity 149. As another example, thermal rods can be disposed within the cavity, and the temperature of the thermal rods transfers to the liquid 191 within the cavity 149. The temperature regulating device 167 can be coupled to a controller 104 (in this case, controller 104-2), using signal transfer links 105, to receive power, control, and instructions from the controller 104, as well as to provide data and feedback to the controller 104. The pressure regulating device 168 and the temperature regulating device 167 can more generally be referred to herein as regulating devices.

In certain example embodiments, the contents (e.g., liquid 191, gas 195) within the cavity 149 of the vessel 140 can be agitated. As discussed below, parameters (e.g., voltage, current) associated with the power used to move the agitator can be measured by one or more sensor devices 160. The agitation of the contents within the cavity 149 can occur in one or more of a number of ways. Examples of how the contents within the cavity 149 can be agitated can include, but are not limited to, stirring, shaking, inversion, and centrifugal rotation,

In this case, a mixing device 150 is used to agitate (e.g., stir) the contents within the cavity 149. The mixing device 150 can include one or more of a number of components. Examples of such components can include, but are not limited to, a motor, a paddle, an impeller, a stir bar, compressed air, a vibrating frame (e.g., for a shaker table), a gear box, a recirculation pump, one or more baffles, magnets (for magnetically coupling the motor 157 to the paddle 155), and a shaft. If there are multiple components used for mixing, agitating, and/or otherwise disturbing the contents within the cavity 149 of the vessel 140, such components can be used individually (at different times) from each other and/or in conjunction with (at the same time as) each other. In this case, the mixing device 150 can include a paddle 155 that is disposed in the cavity 149 and rotated within the cavity 149 by a motor 157 (e.g., a variable frequency drive), which is disposed on the outer surface 165 of the cover 145.

There can also be one or more optional components or devices within the cavity 149 to aid in agitating the contents within the cavity 149 of the vessel 140. For example, as shown in FIG. 1B, one or more baffles 192 can be disposed within the cavity 149 to control how the liquid 191 flows as the liquid 191 is stirred by the paddle 155. Similarly, as discussed in more detail below, features and/or textures on the inner surface 162 of the wall 141 of the body 144, on the outer surfaces of the baffles 192, and/or on the outer surfaces of the paddle 155 can affect the rate at which the gas 195 is evolved and/or dissolved.

In certain example embodiments, there can be one or more view ports 142 disposed in the wall 141 of the body 144 and/or the wall 146 of the cover 145. In this case, there are five view ports 142 (view port 142-1, view port 142-2, view port 142-3, view port 142-4, and view port 142-5) disposed in the wall 141 of the body 144 of the vessel 140. In such a case, one or more image capture devices 135 (e.g., still camera, video camera) can be used to capture images of the contents within the cavity 149 through a viewport 142. An image capture device 135 can use one or more of any number of image capturing technologies, including but not limited to thermal, infrared, and digital. The image capture device 135 can be coupled to a controller 104 (in this case, controller 104-1), using signal transfer links 105, to receive power, control, and instructions from the controller 104, as well as to provide data and feedback to the controller 104.

The body 144 of the vessel 140 can include one or more drain plugs 143 disposed in the wall 141 of the body 144. The drain plug 143 can be used for pressure relief and/or to drain the liquid 191 within the cavity 149. A drain plug 143 can be disposed at any location in the wall 141 of the body 144. For example, in this case, the drain plug 143 is located in the wall 141 that defines the bottom of the body 144 of the vessel 140.

In certain example embodiments, there can be one or more ports 196 through which one or more sensor devices 160 (or portions thereof) can be disposed. These ports 196 can penetrate some or all of the wall 141 of the body 144 and/or some or all of the wall 146 of the cover 145 of the vessel 140. One or more ports 196 can also traverse a wall (e.g., wall 141) of the vessel 140 to allow for the injection and/or removal of a liquid (e.g., liquid 191) and/or a gas (e.g., gas 195) relative to the cavity 149 of the vessel 140. Piping 185, described below, can be used to deliver gas 195 and/or liquid 191 to and/or retrieve gas 195 and/or liquid 191 from the cavity 149 of the vessel 140. In such a case, the inner surface of some or all of the piping 185 can include features and/or textures described below with respect to FIGS. 3A-6B for affecting the rate of evolution and/or dissolution of the gas 195.

In certain example embodiments, the system 100 can include one or more sensor devices 160. The one or more sensor devices 160 can be any type of sensing device that measures one or more parameters. Examples of types of sensor devices 160 can include, but are not limited to, an ammeter, a volt meter, a VAR meter, a gas chromatograph, an ohmmeter, a Hall Effect current sensor, a thermistor, a vibration sensor, an accelerometer, a passive infrared sensor, a photocell, a pressure sensor, an ultrasonic sensor, a gamma densitometer, a thermometer, a thermocouple, and a resistance temperature detector. A parameter that can be measured by a sensor device 160 can include, but is not limited to, current, voltage, gas composition, power, resistance, vibration, position, pressure, flow, acceleration, and temperature.

In some cases, the parameter or parameters measured by a sensor device 160 can be communicated by the sensor device 160 to a controller 104. Further, a sensor device 160 can receive instructions (e.g., when to take measurements, how long to take measurements, the types of measurements to be taken) from a controller 104. For this to occur, each sensor 160 can use one or more of a number of communication protocols. A sensor device 160 can be located within its own housing as its own device. Alternatively, a sensor device 160 can be incorporated with another component (e.g., temperature regulating device 167, pressure regulating device 168) of the system 100. In certain example embodiments, a sensor device 160 can include one or more components (e.g., hardware processor, memory, energy storage device, power module) found in a controller 104, as described below.

In this example, there are five sensor devices 160 in the system 100. Sensor device 160-1 measures a pressure within the cavity 149 of the vessel 140. Sensor device 160-2 measures a flow rate within a pipe 185. Sensor device 160-3 measures a temperature of the wall 141 of the body 144 of the vessel 140. Sensor device 160-4 measures the power delivered to the motor 157 of the mixing device 150. The system 100 can have multiple sensor devices 160 that measure the same parameter but that have different locations throughout the system 100. For example, there can be multiple sensor devices 160-2 that measure flow in different pipes 185 in the system 100.

In certain example embodiments, the system 100 can include one or more PV content sources 170, where each PV content source 170 holds a different gas and/or liquid. In this case, there are three PV content sources 170 (PV content source 170-1, PV content source 170-2, and PV content source 170-3). When there are multiple PV content sources 170, one PV content source 170 can have the same content or a different content relative to the content contained in the other PV content sources 170 in the system 100 and/or the gas 195 and liquid 191 in the cavity 149 of the vessel 140. Each PV content source 170 can be connected to the vessel 140 by piping 185.

The piping 185 can include tubular segments that are coupled end-to-end to transport liquid and/or gas from one location (e.g., PV content source 170-1) to another location (e.g., the vessel 140). The piping 185 can be of any size, made of any suitable material, and can be bent or otherwise shaped for efficient routing. The piping 185 can also include fittings, glands, sleeves, and/or any other suitable components used to create and maintain a piping system. As discussed above, one or more control devices 175 (e.g., valves, regulators) can be used to regulate the medium (e.g., liquid, gas) that flows through the piping 185. These control devices 175 can be adjusted manually by a user. In addition, or in the alternative, a control device 175 can be controlled by a controller 104 using signal transfer links 105. In such a case, the controller 104 can control the control device 175 automatically (e.g., according to a procedure or algorithm) or by user instruction.

One or more pumps 180 can be included in the system 100 to facilitate the transfer of a liquid and/or gas from one location in the system 100 to another. For example, in this case, a pump 180 is used, through piping 185, to create an amount of flow rate of the liquid and/or gas through the piping 185. The pump 180 can use any of a number of technologies. For example, the pump 180 can be a continuous flow syringe pump. As another example, the pump 180 can be a piston cylinder pump. The operation of the pump 180 can be controlled manually by a user. In addition, or in the alternative, a pump 180 can be controlled by a controller 104 (in this case, controller 104-1) using signal transfer links 105. In such a case, the controller 104 can control the pump 180 automatically (e.g., according to a procedure or algorithm) or by user instruction. In some alternative embodiments, a pre-pressurized sample of gas and/or liquid can be delivered to the vessel 140, with or without the use of a pump 180.

Also as discussed above, the system 100 can be used in a laboratory-type setting or in a field application (e.g., at a plant, in a processing facility, at a production facility). In any case, measures can be taken to ensure that the system 100 is safe during operation. For example, the vessel 140 can be an explosion-proof enclosure. According to applicable industry standards, an explosion-proof enclosure is an enclosure that is configured to contain an explosion that originates inside, or can propagate through, the enclosure. Applicable standards for explosion-proof enclosures are established and maintained by the National Electrical Manufacturers Association (NEMA). As another example, the vessel 140 can be rated under applicable standards for subterranean and/or subsea environments.

Also as discussed above, the system 100 can include one or more controllers 104. In this example, there are four controllers 104. Controller 104-1 controls the operation of the pump 180. Controller 104-2 controls the operation of the temperature control device 167. Controller 104-3 controls the operation of the pressure control device 168. Controller 104-4 acts as a master controller or network manager by controlling controller 104-1, controller 104-2, and controller 104-3. The four controllers 104 of FIG. 1A can be individual controllers that communicate with each other. Alternatively, the four controllers 104 of FIG. 1A can be compartmentalized functions within a single controller 104.

A controller 104 can include any of a number of components. Examples of such components, can include, but are not limited to, a control engine, a communication module, a timer, an energy storage device, a power module, a storage repository, a hardware processor, a memory, a transceiver, an application interface, and a security module. Details of a controller 104 can be found in U.S. patent application Ser. No. 15/385,059, titled “Systems and Methods For Gas Evolution and Dissolution” and filed on Dec. 20, 2016, the entire contents of which are hereby incorporated herein by reference.

Triggered by pressure drops (e.g., from control devices 175 (e.g., valves), pipes 185) upstream of the vessel 140, the gas 195 may evolve from the liquid 191. In the current art, process simulators assume that the solution gas 195 evolves instantaneously from the liquid 191. Using example embodiments, the size-dependent rise velocities of entrained bubbles of the gas 195 can control the rate of mass transfer from the bulk liquid 191 to bulk gas 195 phases.

FIGS. 2A-2D show a cycle for evolving gas in accordance with certain example embodiments. Specifically, FIG. 2A shows a cross-sectional top view of a wall 241 of a vessel 240 during the bubble nucleation phase of evolution of a gas 295. FIG. 2B shows a cross-sectional top view of a wall 241 of a vessel 240 during the growth phase of evolution of the gas 295. FIG. 2C shows a cross-sectional top view of a wall 241 of a vessel 240 during the detachment phase of evolution of the gas 295. FIG. 2D shows a cross-sectional top view of a wall 241 of a vessel 240 during the rise, continued growth, and coalescence phase of evolution of the gas 295.

Referring to FIGS. 1A-2D, gas evolution begins with an initially dissolved gas 295 from liquid 291 through bubble nucleation (shown in FIG. 2A), growth (shown in FIG. 2B), detachment (shown in FIG. 2C), and continued growth, rise, and coalescence (shown in FIG. 2D). The fate of a gas bubble 295 formed at a single nucleation site is shown in FIG. 2A. Gas evolution rates are thus expected to depend on the rates of bubble nucleation, growth, rise and coalescence at bulk gas/liquid interface 297.

To affect (e.g., accelerate, slow) the rate of evolution during the bubble nucleation phase, shown as an example in FIG. 2A, there can be one or more of any of a number of example surface treatments 270 that can be applied to and/or disposed on a surface (e.g., inner surface 262) of a wall (e.g., wall 241) of a vessel (e.g., vessel 240, piping 185, control device 175). Examples of other surface treatments are shown below with respect to FIGS. 3A-6B. For example, a surface treatment 270 can be a V-shaped notch in the inner surface 262 of the wall 241. The resulting cavity can host one or more molecules of gas 295 where pseudo-classical nucleation can occur.

The characteristics (e.g., shape, width 271, height 272, smooth surfaces, flat surfaces) of the surface treatment 270 relative to the critical bubble radius (governed by the Laplace equation for the bubble of the gas 295) can determine whether the surface treatment 270 can facilitate the gas evolution cycle for the bubble of gas 295. Further, if the surface treatment 270 can facilitate the evolution cycle for the bubble of gas 295, the characteristics of the surface treatment 270 can also affect the rate at which the evolution cycle of the gas 295 can occur.

For example, a user may want to encourage bubbles of the gas 295 to nucleate and therefore enhance the evolution rate of the gas 295. For this to occur, the size (e.g., width 271, height 272) of the surface treatment 270 can be increased, thereby allowing for the production of bubbles of gas 295 above the critical radius necessary for nucleation. FIGS. 2A-2B show that the surface features 270 are disposed on the inner surface 262 of the wall 241 of a vessel 240 (which can be substantially similar to the vessel 140 discussed above with respect to FIGS. 1A and 1B), example surface features 270 can be disposed on one or more surfaces of one or more other components of a system (e.g., system 100). In addition, or in the alternative, example surface features 270 can be disposed on one or more surfaces of one or more other components (e.g., other vessels, components disposed within a cavity of the vessel 240) of a system. Examples of such other components can include, but are not limited to, piping (e.g., piping 185), control devices (e.g., control devices 175), plates, baffles, weirs, vessel internals, and PV content sources (PV content source 170). Such other components can be located upstream of the vessel 240.

With a lack of surface features (e.g., polished or highly smoothened surfaces), bubble nucleation occurs at very high driving forces (supersaturation levels), thereby slowing the rate of bubble nucleation of the gas 295 as well as the evolution of the gas 295. It should be noted that reversing the process (FIG. 2D to FIG. 2C to FIG. 2B) can be used to illustrate dissolution of a gas in a liquid. Nucleation as shown in FIG. 2A is not involved in the gas dissolution process.

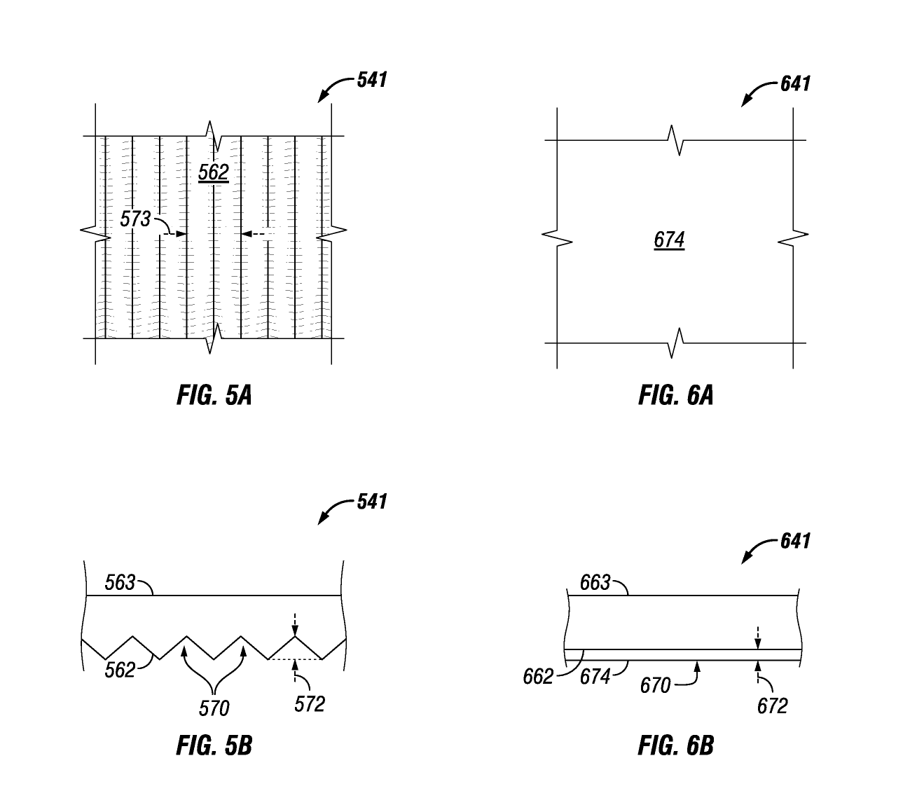

FIGS. 3A-6B shows various surface treatments in accordance with certain example embodiments. Specifically, FIGS. 3A and 3B show a front view and a top view, respectively, of a wall 341 of a vessel, where the wall 341 includes a number of surface features 370 in accordance with certain example embodiments. FIGS. 4A and 4B show a front view and a top view, respectively, of another wall 441 of a vessel, where the wall 441 includes a number of surface features 470 in accordance with certain example embodiments. FIGS. 5A and 5B show a front view and a top view, respectively, of yet another wall 541 of a vessel, where the wall 541 includes a number of surface features 570 in accordance with certain example embodiments. FIGS. 6A and 6B show a front view and a top view, respectively, of still another wall 641 of a vessel, where the wall 641 includes a number of surface features 670 in accordance with certain example embodiments.

Referring to FIGS. 1-6B, changing the characteristics of one or more surfaces that define and/or are disposed within a volume of space in which a gas is undergoing evolution and/or dissolution can change the rate at which those processes occur for that gas. As noted above, the nucleation of bubbles of solution gas due to a supersaturated state is the initial step in the overall gas evolution process. One of the well-known drivers for bubble nucleation (as well as subsequent steps such as bubble rise/detachment) is the size of bubble or cavity formed initially. Gas evolution can take longer if smaller or fewer bubbles are present in the supersaturated system. Therefore, manipulation of these characteristics can inhibit or enhance evolution rates.

In FIGS. 3A and 3B, the surface features 370 are rounded protrusions that extend outward from the inner surface 362 of the wall 341. The surface features 370 in this case are circular (when viewed from the front, as in FIG. 3A) in shape, so that the length 371 and the width 373 of a surface feature 370 are equal to each other. In alternative embodiments, the length 371 and the width 373 of a surface feature 370 can be different from each other, giving a non-circular (e.g., oval, elliptical) shape to the surface feature 370. Other example shapes of a surface feature 370 can include, but are not limited to, square, octagonal, and random.

In addition, the shape and/or size of one surface feature 370 can be the same as, or different than, the shape and/or size of one or more of the other surface features 370. Each surface feature 370 also has a thickness 372, which defines how far the surface feature 370 protrudes from the wall 341. The thickness 372 of one surface feature 370 can be the same as, or different than, the thickness 372 of one or more other surface features 370. The outer surface 363 of the wall 341 in this case has no surface features, as gas (e.g., gas 195) only interacts with the inner surface 362 of the wall and not the outer surface 363.

Also, while the walls of the surface features 370 are shown to be smooth and curved uniformly throughout, these aspects can be changed in alternative embodiments. For example, a wall of a surface feature 370 can be textured. As another example, a wall of a surface feature 370 can include one or more of a number of planar segments that abut against each other. As yet another example, a wall of a surface feature 370 can be smooth but have irregular radial segments.

In FIGS. 4A and 4B, the surface features 470 are rounded recesses that extend inward from the inner surface 462 of the wall 441. The surface features 470 in this case are circular (when viewed from the front, as in FIG. 4A) in shape, so that the length 471 and the width 473 of a surface feature 470 are equal to each other. In alternative embodiments, the length 471 and the width 473 of a surface feature 470 can be different from each other, giving a non-circular (e.g., oval, elliptical) shape to the surface feature 470. Other example shapes of a surface feature 470 can include, but are not limited to, square, octagonal, and random.

In addition, the shape and/or size of one surface feature 470 can be the same as, or different than, the shape and/or size of one or more of the other surface features 470. Each surface feature 470 also has a thickness 472, which defines how far the surface feature 470 recesses into the wall 441. The thickness 472 of one surface feature 470 can be the same as, or different than, the thickness 472 of one or more other surface features 470. The outer surface 463 of the wall 441 in this case has no surface features, as gas (e.g., gas 195) only interacts with the inner surface 462 of the wall and not the outer surface 463.

Also, while the walls of the surface features 470 are shown to be smooth and curved uniformly throughout, these aspects can be changed in alternative embodiments. For example, a wall of a surface feature 470 can be textured. As another example, a wall of a surface feature 470 can include one or more of a number of planar segments that abut against each other. As yet another example, a wall of a surface feature 470 can be smooth but have irregular radial segments.

In FIGS. 5A and 5B, the surface features 570 are sawtooth-shaped protrusions and/or recesses that extend outward and inward from the inner surface 562 of the wall 541. The surface features 570 in this case are linear (when viewed from the top, as in FIG. 5B) in shape, so that the width 573 of a surface feature 570 is equal to each other. In alternative embodiments, the width 573 of a surface feature 570 can be different from each other, giving a non-linear (e.g., curved segments) shape and/or segments having shorter and/or longer widths 573 of the surface feature 570. Further, instead of two segments forming a surface feature 570, more than two (e.g., three, four, six) segments can be used to form a surface feature 570. When a surface feature 570 has multiple segments, one segment can have the same or different features (e.g., curvature, width) as one or more of the other segments of the surface feature 570.

In addition, the shape and/or size of one surface feature 570 can be the same as, or different than, the shape and/or size of one or more of the other surface features 570. Each surface feature 570 also has a thickness 572, which defines how far the surface feature 570 recesses into and/or protrudes out of the wall 541. The thickness 572 of one surface feature 570 can be the same as, or different than, the thickness 572 of one or more other surface features 570. The outer surface 563 of the wall 541 in this case has no surface features, as gas (e.g., gas 195) only interacts with the inner surface 562 of the wall and not the outer surface 563.

Also, while the walls of the surface features 570 are shown to be smooth and planar uniformly throughout, these aspects can be changed in alternative embodiments. For example, a wall of a surface feature 570 can be textured. As another example, a wall of a surface feature 570 can include one or more of a number of curved segments that abut against each other. As yet another example, a wall of a surface feature 570 can be smooth but have irregular radial segments.

In FIGS. 6A and 6B, the surface feature 670 is a coating disposed on the inner surface 662 of the wall 641. The surface feature 670 in this case has a thickness 672. The coating of the surface feature 670 can be one or more of any of a number of materials (e.g., carbon nanotubes, nano-silica, polytetrafluoroethylene (PTFE), Gore-Tex®, fluorocarbons, perfluorocarbons (PFCs)) having one or more of any of a number of characteristics (e.g., smooth, adhesive, repellant). (Gore-Tex is a registered trademark of W. L. Gore and Associates.)

The coating can be hydrophobic, super-hydrophobic, hydrophilic, oleophobic, have some other characteristic, or have any combination thereof. For example, the coating can be both hydrophobic and oleophobic to allow for increasing gas evolution regardless of the continuous phase liquid throughout the production life. The coating of the surface feature 670 can be applied to the inner surface 662 of the wall 641 evenly, unevenly, randomly, in a pattern, and/or in any other fashion.

In any case, when one or more surface features are disposed on a surface (e.g., an inner surface of a vessel, an inner surface of a pipe, an inner surface of a valve, an outer surface of a paddle, an outer surface of a baffle) in the system, the surface features can be disposed on all or a portion of the surface. Further, there can be one or more of a number of different surface features disposed on a surface. For example, a surface can have a number of surface features in the form of recesses (as shown in FIGS. 3A and 3B) as well as a coating (as shown in FIGS. 6A and 6B).

In addition, when surface features are disposed on surface, the surface features can be laid out in an organized pattern or randomly. Evolution and/or dissolution of a gas can occur on a surface feature and/or adjacent to a surface feature. For example, when the surface features are protrusions from the inner surface of a vessel, evolution of a gas can occur on the inner surface adjacent to the surface features. Further, the scale of the surface features described herein can be on the order of any of a number of units of measurement, including but not limited to meters, millimeters, micrometers, and nanometers.

Using example embodiments described herein, it is possible to control the rate at which a gas can evolve and/or dissolve when combined with a known liquid under a given set of conditions. With example embodiments, one or more surfaces that are exposed to the gas include one or more of a number of features. These features can be used to control (e.g., accelerate, retard) the rate at which the gas evolves and/or dissolves under a given set of conditions (e.g., pressure, temperature). The surfaces that include these example features can be in the vessel in which the gas is evolved and/or dissolved. In addition, or in the alternative, the surfaces that include these example features can be in one or more components (e.g., piping, control devices) located upstream of the vessel. As a result of using example embodiments, significant cost and time savings can be realized across a number of industries and/or applications in which gases are evolved and/or dissolved.

Gas exists either as bulk phase or is within the bulk liquid phase as entrained bubbles and dissolved gas. Typically, a pressure drop (for example, due to control devices (e.g., valves)) is taken upstream of the vessel (e.g., vessel 140). In theory, this pressure drop should disengage some of the dissolved gas. Design tools currently known in the art incorrectly assume that this disengagement is instantaneous. The disengagement is controlled by gas evolution rates, and in instances where the gas does not fully disengage, performance of the vessel is hampered. Such degradation of vessel performance has grave consequences ranging from downstream equipment damage to an adverse impact on production rates due to increased backpressure. Development of specific system modifications targeted at example surface features can allow for better control of the gas evolution process. Specifically, application of example surface features post-installation can allow for increased reliability, uptime, and efficiency from separations and downstream liquids handling equipment. Application of example surface features during installation or design phases can ensure the expected extent of gas-liquid separation in the process.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A system for changing a state of a gas relative to a liquid, the system comprising:
a vessel comprising at least one wall forming a cavity, wherein the at least one wall comprises at least one first surface feature disposed on an inner surface of the at least one wall,
wherein the liquid and the gas are disposed within the cavity, and
wherein the at least one first surface feature alters the rate at which the gas evolves from or dissolves into the liquid.

2. The system of claim 1, further comprising:
a mixing device that mixes the liquid and the gas within the pressure vessel, wherein the mixing device comprises paddle is disposed within the cavity of the pressure vessel, wherein the paddle comprises at least one second surface feature disposed on an outer surface of the paddle.

3. The system of claim 1, wherein the vessel is a pump, and wherein the gas is dissolved in the liquid.

4. The system of claim 1, wherein the at least one first surface feature comprises a coating on an inner surface of the at least one wall of the vessel.

5. The system of claim 1, wherein the at least one first surface feature comprises a plurality of protrusions disposed on an inner surface of the at least one wall of the vessel.

6. The system of claim 1, wherein the at least one first surface feature comprises a plurality of depressions disposed on an inner surface of the at least one wall of the vessel.

7. The system of claim 1, wherein the at least one first surface feature is disposed randomly on an inner surface of the at least one wall of the vessel.

8. The system of claim 1, wherein the at least one first surface feature is disposed in an organized pattern on an inner surface of the at least one wall of the vessel.

9. The system of claim 1, wherein the at least one first surface feature comprises a plurality of first surface features, wherein each first surface feature of the plurality of first surface features is on the order of micrometers in diameter.

10. The system of claim 1, wherein each first surface feature of the plurality of first surface features is on the order of nanometers in diameter.

11. The system of claim 1, further comprising:
at least one baffle disposed in the cavity.

12. The system of claim 11, wherein the at least one baffle comprises at least one second surface feature disposed on an outer surface of the at least one baffle.

13. The system of claim 1, wherein the vessel is a pressure regulating device.

14. The system of claim 1, wherein the at least one first surface feature inhibits evolution and dissolution of the gas.

15. The system of claim 1, wherein the at least one first surface feature enhances evolution and dissolution of the gas.

16. The system of claim 1, wherein the at least one first surface feature affects bubble nucleation of the gas from the liquid.

17. The system of claim 1, wherein the at least one first surface feature affects growth of a gas bubble.

18. The system of claim 1, wherein the at least one first surface feature affects detachment of the gas from the at least one wall.

19. A system for changing a state of a gas relative to a liquid, the system comprising:
a vessel comprising at least one wall forming a cavity; and
a component disposed within the cavity, wherein the component comprises at least one outer surface on which at least one first surface feature is disposed,
wherein the liquid and the gas are disposed within the cavity, and
wherein the at least one first surface feature alters the rate at which the gas evolves from or dissolves into the liquid.

20. A pipe used to feed a gas to a vessel used for changing a state of the gas relative to a liquid, wherein the pipe comprises at least one wall forming a cavity, wherein the at least one wall comprises at least one first surface feature disposed on an inner surface of the at least one wall, wherein the gas is disposed within the cavity, and wherein the at least one first surface feature alters the manner in which the gas travels through the cavity to the vessel.
